(19) United States
(12) Patent Application Publication
(10) Pub. No.: US 2009/0103710 A1
(43) Pub. Date: Apr. 23, 2009

(54) METHOD, SYSTEM AND APPARATUS FOR ROUTING

(76) Inventors: Kaiping Ding, Shenzhen (CN); Zhongchu Zhu, Shenzhen (CN)

Correspondence Address: BRINKS HOFER GILSON & LIONE, P.O. BOX 10395, CHICAGO, IL, 60610, US

(21) Appl. No.: 12/342,374

(22) Filed: Dec. 23, 2008

Related U.S. Application Data
(63) Continuation of application No. PCT/CN2007/071049, filed on Nov. 12, 2007.

(30) Foreign Application Priority Data
Dec. 26, 2006 (CN) 200610167184.6

(51) Int. Cl. H04M 3/00

(52) U.S. Cl. 379/265.11

(57) ABSTRACT

A method for routing includes upon receipt of a routing analysis request, analyzing a preset routing rule according to the contents in the routing analysis request to obtain the data source information corresponding to the routing rule and routing the contents in the routing analysis request to the data source corresponding to the obtained data source information. An embodiment of the disclosure also provides a system and an apparatus for routing. The method, system, and apparatus provided by embodiments of the present disclosure may improve the routing flexibility and data processing efficiency.

### CROSS REFERENCES TO RELATED APPLICATIONS

This application is a continuation application of PCT/CN2007/071049, filed Nov. 12, 2007 which claims priority to the Chinese Patent Application No. 200610167184.6, filed with the Chinese Patent Office on Dec. 26, 2006 and entitled “Method, System and Apparatus for Routing”, the contents of which are incorporated herein by reference in their entirety.

### FIELD OF THE DISCLOSURE

The present disclosure relates to network communications, and in particular, to a method, system, and apparatus for routing.

### BACKGROUND OF THE DISCLOSURE

Currently, enterprise-class communication systems have requirements for supporting communications between multiple data sources or protocol systems. In traditional Internet applications, however, each communication system generally interacts with one data source only for routing, and the data source may be specified by a user. This routing mode involving a single data source may lead to large redundancy in the data storage, cause difficulties in data classification and maintenance of a system, and affect the data processing efficiency, for example, data access efficiency.

### SUMMARY OF THE DISCLOSURE

An embodiment of the present disclosure provides a method, a system, and an apparatus for routing to improve the routing flexibility and data processing efficiency.

To achieve the preceding objectives, the technical solution provided in an embodiment of the present disclosure is described below.

A method for routing provided in an embodiment of the disclosure includes upon receipt of a routing analysis request, analyzing a preset routing rule according to the contents in the routing analysis request, and obtaining the data source information corresponding to the routing rule, and routing the contents in the routing analysis request to the data source corresponding to the obtained data source information.

A system for routing provided in an embodiment of the disclosure includes a routing request module adapted to send a routing analysis request to a routing execution module, a routing execution module adapted to obtain the routing rule from a database, analyze the obtained routing rule according to the received routing analysis request to obtain the data source information corresponding to the routing rule, and route the contents in the analysis request to the data source corresponding to the obtained data source information, and a database, adapted to store and provide routing rules.

An apparatus for routing provided in an embodiment of the disclosure includes a receiving module adapted to receive a routing analysis request, an obtaining module adapted to obtain a routing rule, an analysis module adapted to analyze the obtained routing rule according to the contents in a routing analysis request received by the receiving module and obtain the data source information corresponding to the routing rule, and a routing module adapted to route the contents in the routing analysis request received by the receiving module to the data source corresponding to the data source information obtained by the analysis module.

Compared with the conventional art, the method, system, and apparatus for routing provided in an embodiment of the present disclosure can improve the routing flexibility and data processing efficiency.

### BRIEF DESCRIPTION OF THE DRAWINGS

FIG. 1 shows a structure of a system for routing according to an embodiment of the present disclosure;

FIG. 2 shows a structure of a binary tree;

FIG. 3 shows a process of setting and storing the routing rule according to an embodiment of the present disclosure;

FIG. 4 shows a process of routing according to the preset routing rule in an embodiment of the present disclosure;

FIG. 5 shows a process of analyzing the routing rule according to embodiment of the present disclosure; and

FIG. 6 shows an apparatus for routing according to embodiment of the present disclosure.

### DETAILED DESCRIPTION OF THE DISCLOSURE

The following describes the disclosure in detail with reference to the accompanying drawings and embodiments.

The method for routing according to an embodiment of the present disclosure includes upon receipt of a routing analysis request, analyzing the preset routing rule according to the contents in a routing analysis request to obtain the data source information corresponding to the routing rule and routing the contents in the routing analysis request to the data source corresponding to the obtained data source information.

The system for routing according to an embodiment of the present disclosure includes a routing request module, a routing execution module, and a database, which are connected in turn. The routing request module is adapted to send a routing analysis request to the routing execution module according to a received service request. The routing execution module is adapted to obtain the routing rule from the database and analyze the obtained routing rule according to the received routing analysis request to obtain the data source information corresponding to the routing rule and route the contents in the analysis request to the data source corresponding to the obtained data source information. The database is adapted to store and provide the routing rule.

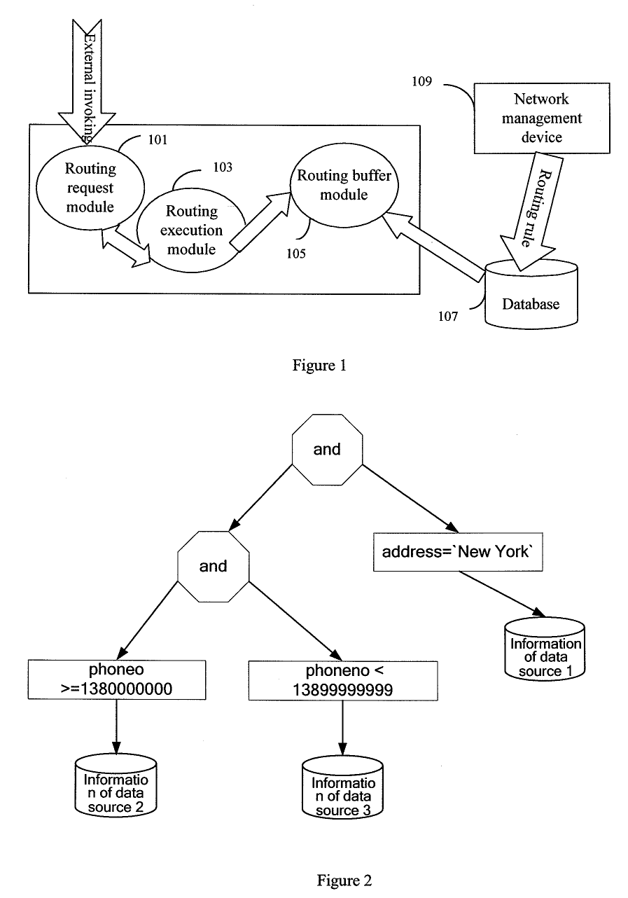

FIG. 1 shows a structure of the system for routing provided in an embodiment of the present disclosure. As shown in FIG. 1, a routing request module 101, a routing execution module 103, a routing buffer module 105, a database 107, and a network management device 109 are connected in turn.

To ensure the routing flexibility, a user may preset a flexible routing rule in the network management device. The preset routing rule refers to the mapping between specific factors and the information of a data source to which the specific factors are routed. For example, different data source identifications (IDs) correspond to different communication conditions, different data source IDs correspond to different naming-structured query languages (Naming-SQL), and different data source IDs associate different service modules.

When receiving the routing rule preset by the user, the network management device delivers the received routing rule to the database for storing. The network management device delivers the routing rule to the database in the following mode: the network management device invokes the writing database interface between the network management device and the database and writes the routing rule into the database through such interface. The routing rule is generally stored in the routing rule table of the database.

After being activated, the routing buffer module may load the routing rule stored in the database through the following steps: The routing buffer module sends a request for loading the routing rule to the database. The database sends the stored routing rule to the routing buffer module after receiving the request. The routing buffer module stores the routing rule from the database.

In practical applications, the routing rule stored in the network management device may be changed. After receiving a new routing rule, the network management device updates the routing rule that is previously stored and needs to be changed by using the received new routing rule. Besides, the network management device sends the updated routing rule to the database so that the database updates the routing rule that is previously stored in the database by using the received new routing rule. In this case, the routing buffer module always loads the most recent routing rule from the database. In addition, the routing buffer module sends an update query request to the database on a timed or periodical basis to check whether the routing rules stored in the database are updated according to the feedback from the database and to load the updated routing rules from the database when the routing rules are updated.

After setting and storing the routing rule, the routing request module may receive operation information from a user. The operation information includes specific factors related to the routing rule, for example, user's communication conditions and Naming-SQL. The operation information also includes content, such as the data, to be routed. In addition, if the user specifies a route, for example, specific data source information, the operation information may include the data source information specified by the user, for example, data source ID. The operation information is included in the service request from the user.

After receiving a service request from the user, the routing request module may judge whether the service request involves a routing operation according to the conventional art. If the routing operation is involved, the routing request module sends the received operation information to the routing execution module. Otherwise, the routing request module does not perform any subsequent operation. The operation information is carried in a routing analysis request and sent to the routing execution module.

After receiving the routing analysis request from the routing request module, the routing execution module determines the routing operation to be performed, obtains, by the mode as read, the routing rule from the routing buffer module, and analyzes the read routing rule according to the operation information in the routing analysis request to obtain the corresponding data source information.

The operation information may include a user's communication conditions and Naming-SQL. Specifically, when reading the user's communication conditions from the operation information, the routing execution module searches for the data source information corresponding to the user's communication conditions in the routing rule stored in the routing buffer module and routes the contents in the routing analysis request to the data source corresponding to the searched data source information. For example, when reading the user's communication conditions from the operation information, the routing execution module obtains by the mode as read, the routing rule from the routing buffer module, searches for the data source ID corresponding to the user's communication conditions searched in the routing rule, and routes the contents in the routing analysis request to the data source corresponding to the data source ID searched.

If the data source information corresponding to the user's communication conditions is not found, the routing execution module may read the Naming-SQL from the operation information, search for the data source information corresponding to the read Naming-SQL in the routing rule stored in the routing buffer module, and route the contents in the routing analysis request to the data source corresponding to the searched data source information. For example, when reading the Naming-SQL from the operation information, the routing execution module obtains by the mode as read, the routing rule from the routing buffer module, searches the data source ID corresponding to the Naming-SQL read in the obtained routing rule, and routes the contents in the routing analysis request to the data source corresponding to the searched data source ID.

If the data source information corresponding to the Naming-SQL is not found, the routing execution module may read the contents to be routed from the operation information, determine the service module for processing the contents to be routed according to the conventional art, search for the data source information corresponding to the service module in the routing rule stored in the routing buffer module, and route the contents to the data source corresponding to the searched data source information. For example, after determining the service module for processing the contents to be routed, the routing execution module obtains by the mode as read, the routing rule from the routing buffer module, searches for the data source ID corresponding to the service module, and routes the contents to the data source corresponding to the searched data source ID.

In conclusion, the routing execution module may determine the data source according to such specific factors as user's communication conditions, Naming-SQL, and service module for processing the contents to be routed in the following order: user's communication conditions→Naming-SQL→service module for processing the contents to be routed. In this way, the contents to be routed are routed to the data source. In fact, the routing execution module may also determine the data source according to any one or two of specific factors mentioned above. Besides, when the routing execution module determines the data source according to two or more of specific factors mentioned above, the order may be set at random, for example, user's communication conditions→service module for processing the contents to be routed, or Naming-SQL→user's communication conditions→service module for processing the contents to be routed.

It should be noted that when the data source cannot be determined according to the preceding specific factors, the routing execution module may further search for the default data source information preset by the routing execution module and route the contents to be routed to the data source corresponding to the searched data source information. For example, the routing execution module searches for the default data source ID preset by the routing execution module and routes the contents to be routed to the data source corresponding to the searched data source ID. The default data source information may be set in other entities so long as the default data source information can be obtained by the routing execution module when necessary.

Besides, if the operation information includes a route specified by the user, for example, data source information specified by the user, the routing execution module may route the contents to be routed in the routing analysis request following the route specified by the user. For example, the routing execution module routes the contents in the routing analysis request to the data source corresponding to the data source ID specified by the user in the routing analysis request according to the data source ID specified by the user in the routing analysis request.

It is evident that the routing execution module may route data flexibly based on the preset routing rule. This routing flexibility may improve the data processing efficiency. Besides, to improve the data processing efficiency, the mapping of the user's communication conditions involved in the routing rule may be represented by a binary tree shown in FIG. 2.

FIG. 2 shows the simple structure of a binary tree. As shown in FIG. 2, the binary tree may indicate the data source information corresponding to the user's communication conditions simply and visually, for example, address=‘New York’, phoneo>=1380000000, and phoneno<13899999999. Thus, in the situation that the routing buffer module buffers the mapping of the user's communication conditions involved in the routing rule in the form of binary tree, the routing execution module may find the data source information corresponding to the user's communication conditions in the binary tree by the mode as matching with high efficiency. This high efficiency for finding the data source information may further improve the data processing efficiency evidently.

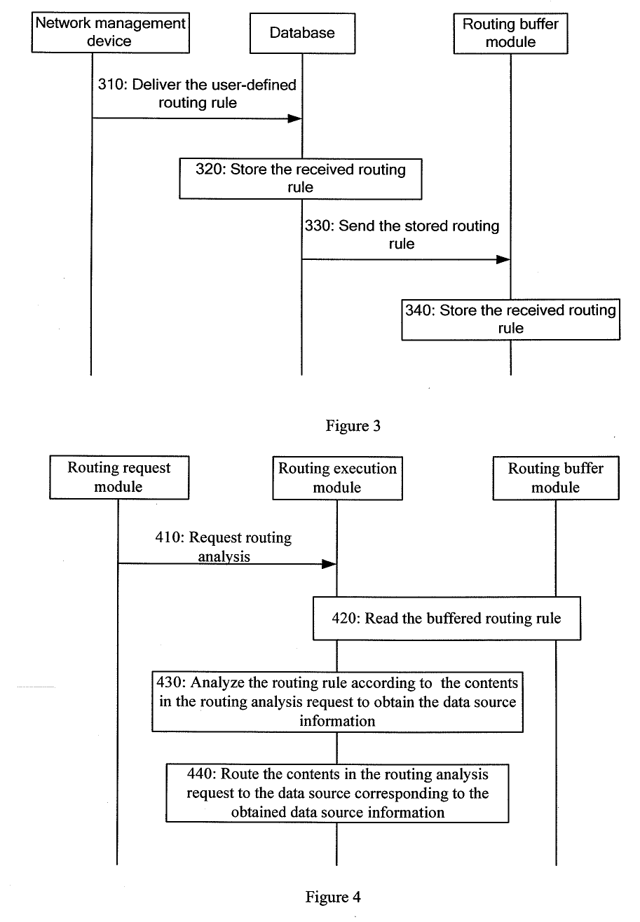

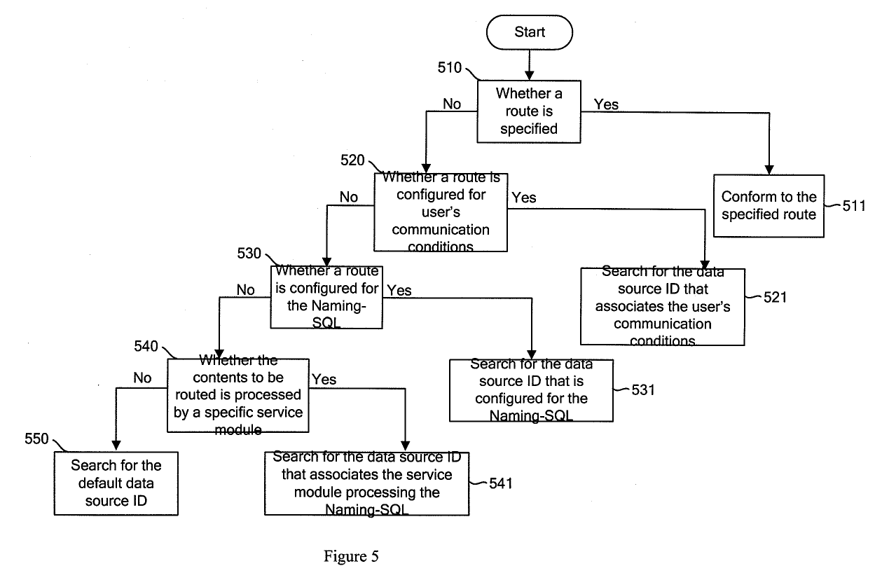

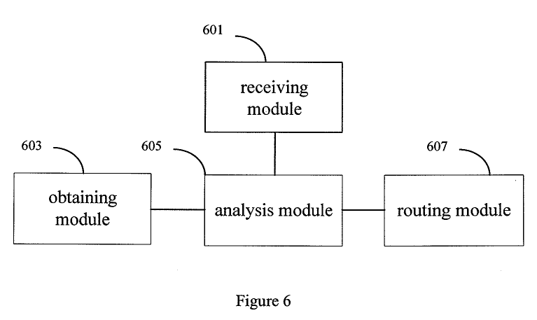

For better understanding of the system operation principle in FIG. 1, routing operations involved are hereinafter described according to FIG. 3 and FIG. 4. FIG. 3 shows the process of setting and storing the routing rule. FIG. 4 shows the process of routing according to the preset routing rule. The operations in FIG. 3 and FIG. 4 are described in detail in FIG. 1 and will be briefly described as follows.

FIG. 3 shows the process of setting and storing the routing rule in an embodiment of the present disclosure. The process includes the following steps:

Step 310: The network management device receives the user-defined routing rule, and delivers the received routing rule to the database.

Step 320: The database stores the routing rule from the network management device.

Step 330: The database sends the stored routing rule to the routing buffer module.

Step 340: The routing buffer module stores the routing rule from the database.

The database may update the routing rule and notify the routing buffer module of updating the routing rule.

FIG. 4 shows the process of routing according to the preset routing rule in an embodiment of the present disclosure. The process includes the following steps:

Step 410: The routing request module receives a service request from the user, determines the service request involved with routing operations, and sends a routing analysis request to the routing execution module.

Step 420: After receiving the routing analysis request from the routing request module, the routing execution module reads the routing rule from the routing buffer module.

Step 430: The routing execution module analyzes the read routing rule according to the contents in the routing analysis request to obtain the corresponding data source information.

Step 440: The routing execution module routes the contents in the routing analysis request to the data source corresponding to the obtained data source information.

The complete process of analyzing the routing rule in step 430 is shown in FIG. 5. The operations in FIG. 5 have been described in detail in FIG. 1 and will be briefly described here.

FIG. 5 shows the process of analyzing the routing rule in an embodiment of the present disclosure. The process includes the following steps:

Step 510: The routing execution module judges whether the user specifies a route. If a route is specified, it goes to step 511. Otherwise, it goes to step 520.

Step 511: Follow the specified route and terminate the routing analysis operation.

Step 520: The routing execution module judges whether a route is configured for the user's communication conditions. If such a route is configured, it goes to step 521. Otherwise, it goes to step 530.

Step 521: The routing execution module searches for the data source ID corresponding to the user's communication conditions and terminates the routing analysis operation.

Step 530: The routing execution module judges whether a route is configured for the Naming-SQL. If such a route is configured, it goes to step 531. Otherwise, it goes to step 540.

Step 531: The routing execution module searches for the data source ID that is configured for the Naming-SQL and terminates the routing analysis operation.

Step 540: The routing execution module judges whether the contents to be routed is processed by a specific service module. If yes, it goes to step 541. Otherwise, it goes to step 550.

Step 541: The routing execution module searches for the data source ID corresponding to the service module processing the Naming-SQL and terminates the routing analysis operation.

Step 550: The routing execution module searches for the default data source ID.

In the preceding embodiments, the main function of the routing buffer module is to store the routing rule in a buffer mode so as to speed up obtaining the routing rule performed by the routing execution module and shorten the routing time. In practical applications, the routing buffer module may not be used when the requirement for routing speed is not very high. The database may be connected to the routing execution module so that the routing execution module can obtain the routing rule from the database directly. Besides, the routing rule may be stored in multiple databases so long as the routing execution module can obtain the routing rule successfully.

An apparatus for routing provided in an embodiment of the disclosure includes a receiving module 601 adapted to receive a routing analysis request, an obtaining module 603 adapted to obtain the routing rule, an analysis module 605 adapted to analyze the obtained routing rule according to the contents in the routing analysis request received by the receiving module and obtain the data source information corresponding to the routing rule, and a routing module 607 adapted to route the contents in the routing analysis request received by the receiving module to the data source corresponding to the data source information obtained by the analysis module.

It is evident that the method, system and apparatus for routing provided in the embodiments of the present disclosure may improve the routing flexibility and data processing efficiency.

What is claimed is:

1. A method for routing, comprising:
upon receipt of a routing analysis request, analyzing a preset routing rule according to contents in the routing analysis request and obtaining data source information corresponding to the routing rule; and
routing contents to be routed in the routing analysis request to a data source corresponding to the obtained data source information.

2. The method of claim 1, wherein the routing rule comprises user's communication conditions and data source information corresponding to the routing rule, and the analyzing the routing rule comprises:
reading the user's communication conditions in the routing analysis request and searching for the data source information corresponding to the user's communication conditions.

3. The method of claim 1, wherein the routing rule comprises a Naming-SQL and data source information corresponding to the Naming-SQL, and the performing routing analysis on the routing rule comprises:
reading the Naming-SQL in the routing analysis request and searching for the data source information corresponding to the read Naming-SQL.

4. The method of claim 1, wherein the routing rule comprises a service module for processing the contents to be routed and data source information corresponding to the service module for processing the contents to be routed and the performing routing analysis on the routing rule comprises:
reading the contents to be routed in the routing analysis request, determining the service module for processing the contents to be routed, and searching for the data source information corresponding to the service module.

5. The method of claim 1, wherein the routing rule comprises user's communication conditions and data source information corresponding to user's communication conditions, Naming-SQL and data source information corresponding to Naming-SQL, a service module for processing the contents to be routed and data source information corresponding to the service module for processing the contents, and the method for performing routing analysis on the routing rule comprises:
reading the user's communication conditions in the routing analysis request and searching for the data source information corresponding to the user's communication conditions,
wherein when data source information corresponding to the user's communication conditions is not found, reading the Naming-SQL in the routing analysis request and searching for the data source information corresponding to the Naming-SQL and wherein when no data source information corresponding to the Naming-SQL is found, reading the contents to be routed in the routing analysis request, determining the service module for processing the contents to be routed, and searching for the data source information corresponding to the service module.

6. The method of claim 2, wherein the routing rule is represented by a binary tree and the searching for the data source information corresponding to the user's communication conditions comprises:
matching the data source information corresponding to the user's communication conditions in the binary tree.

7. The method of claim 2, comprising:
reading the data source information specified by a user in the routing analysis request in advance and conforming to the information.

8. The method of claim 4, comprising:
when data source information corresponding to the service module is not found, searching for the preset default data source information and conforming to the information.

9. The method of claims 1, wherein the routing rule is preset in a database by a network management device, comprising:
by the network management device, invoking a writing database interface between the network management device and the database, and writing the routing rule into the database through the writing database interface.

10. The method of claim 9, further comprising:
buffering the routing rule stored in the database; and
obtaining and analyzing the buffered routing rule when necessary.

11. The method of claim 9, comprising:
updating the stored routing rule.

12. The method of claim 1, wherein the data source information refers to the data source identification (ID).

13. A system for routing, comprising:
a routing request module; and
a routing execution module,
wherein the routing request module is adapted to send a routing analysis request to a routing execution module according to a received service request and the routing execution module is adapted to obtain a routing rule, analyze the obtained routing rule according to the received routing analysis request to obtain data source information corresponding to the routing rule, and route the contents to be routed in the analysis request to the data source corresponding to the obtained data source information.

14. The system of claim 13, further comprising:
a database adapted to store and provide the routing rule.

15. The system of claim 14, wherein,
the database is connected to a network management device,
wherein the network management device is adapted to set the routing rule and send the routing rule to the database for storing.

16. The system of claim 15, wherein,
the network management device is further adapted to update the preset routing rule and send the updated routing rule to the database and the database is further adapted to update the stored routing rule in the database according to the routing rule from the network management device.

17. The system of claim 15, wherein the routing rule is sent through a writing database interface between the network management device and the database.

18. The system of claim 13 further comprising a routing buffer moduleconnected between the routing execution module and the database,
wherein the routing buffer module is adapted to load routing rules that are stored in the database into the routing buffer module for storing and provide the routing execution module with routing rules.

19. The system of claim 13, wherein the routing rule comprises at lease one of user's communication conditions and data source information corresponding to the user's communication conditions, naming-SQL and data source information corresponding to the naming-SQL, and a service module for processing the contents to be routed and data source information corresponding to the service module.

20. An apparatus for routing, comprising:
a receiving module adapted to receive a routing analysis request;
an obtaining module adapted to obtain a routing rule;
an analysis module adapted to analyze the obtained routing rule according to the contents in the routing analysis request received by the receiving module and obtain data source information corresponding to the routing rule; and
a routing module adapted to route the contents in the routing analysis request received by the receiving module to a data source corresponding to the data source information obtained by the analysis module.
